(19) United States
(12) Patent Application Publication
(10) Pub. No.: US 2014/0324199 A1
(43) Pub. Date: Oct. 30, 2014

(54) AUDIO PIPELINE FOR AUDIO DISTRIBUTION ON SYSTEM ON A CHIP PLATFORMS

(71) Applicant: INTEL CORPORATION, Santa Clara, CA (US)

(72) Inventors: Jixing Gu, Shanghai 31 (CN); Chao Li, Shanghai (CN); Hao Shen, Shanghai (CN); Yip Chean Choo, Pulau Pinang (MY)

(21) Appl. No.: 14/129,914

(22) PCT Filed: Dec. 12, 2012
(86) PCT No.: PCT/US12/69290

§ 371 Date: Dec. 27, 2013

(30) Foreign Application Priority Data
Dec. 29, 2011 (MY) PI 2011006360

(51) Int. Cl. G06F 17/30

(52) U.S. Cl. CPC G06F 17/3074
USPC 700/94

(57) ABSTRACT

An audio pipeline for audio distribution on a system on a chip platform is described. In one example, a method includes adding an audio input to a hardware audio module using a pipeline manager coupled to an operating system running on a processor, connecting the audio input to an audio source, adding an audio output to the hardware audio module, and connecting the audio output to an audio sink using the pipeline manager.

### BACKGROUND

ATSC (Advanced Television Standards Committee) and other digital television and video playback standards have ushered in an age of electronic televisions. To support electronic program guides, electronic file players, Internet connectivity and other features, complex software driven systems have been developed. As a result, rather than a single chip hardware solution with few user input options, such as those for a Video Cassette Recorder or Digital Versatile Disk player, televisions and set-top boxes may use an operating system (OS) under microprocessor control. The operating system allows for complex user input devices, such as full keyboards and motion controllers as well as a wide range of configurable options and an ability to add applications for additional functions.

There are many different operating systems currently used to operate televisions and set-top boxes. Some are complex, such as Microsoft Windows, Apple OS X, and Linux. In some cases, these complex full-featured operating systems are stripped of unused features but still rely heavily on a main central processing unit to perform its functions. More recently, smart phone operating systems, such as Windows CE, Apple iOS, and Android have been adopted for use in set top boxes and televisions. These operating systems, while more compact, are intentionally designed for use in a smart phone and to support many different functions in a hardware architecture that relies primarily on a single microprocessor.

Even when adapted specifically for use as a television or set top box operating system, the fundamental OS design is for a single general purpose microprocessor to perform any and all intended functions and to drive any attached devices. The attached devices are typically input and output devices, such as wireless radios, wired data buses, touch screens, or keyboards, or for output, a speaker and display.

Google TV is an example of an OS developed specifically for televisions and set top boxes. It is based on an Android platform and includes, among other smart phone features, several Bluetooth profiles, including Bluetooth Advanced Audio Distribution Profile (A2DP). As is appropriate for smart phone architecture, the data flow is through software into an A2DP software stack and from there direct to a Bluetooth radio for transmission. The processor conducts the audio sample rate conversion and mixing process and manages data output to the Bluetooth radio. However this heavily consumes Central Processing Unit (CPU) bandwidth and impacts its performance. The output audio may be choppy, or have skips when the CPU is interrupted for other tasks. A software configuration also is limited in how many concurrent audio streams it can simultaneously support. In the Google TV example, an A2DP headset and TV speaker cannot concurrently output the audio from a media stream. Similarly the A2DP headset can't output the TalkBack sound and system sound simultaneously. TalkBack is a menu text-reading. These limitations come from the structure of the OS and how it operates with the CPU.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a process flow diagram connecting a hardware audio module using a pipeline manager according to an embodiment of the invention.

FIG. 2 is a layer diagram of a pipeline manager in an audio and video player according to an embodiment of the invention.

FIG. 3 is a block diagram of connections within an audio and video player according to an embodiment of the invention.

FIG. 4 is a block diagram of an audio and video player according to an embodiment of the invention.

### DETAILED DESCRIPTION

Software based audio sample rate converting and mixing puts heavy demands on a CPU and may be interrupted by other processes. By adding dedicated audio processing hardware resources to the CPU, the use of the CPU processing core can be independent of the audio signal processing software stack. With appropriate changes in the OS, this allows Bluetooth A2DP, TalkBack, system sound and other types of audio to be output to A2DP headsets and to other audio sinks without consuming significantly more CPU bandwidth.

In one embodiment, a television or set-top box or other media playback device has an efficient audio pipeline scheme for system sound, media sound, and other sounds to be output through Bluetooth A2DP speakers and other outputs. In one example, an SOC (System on a Chip) includes audio processing resources, for example an Intel CE (Consumer Electronics) SOC includes a central processing core and powerful hardware audio processor so that audio decoding, audio sample rate converting, and audio mixing can be processed by dedicated hardware instead of a general purpose CPU. This frees up the CPU's bandwidth to process other tasks.

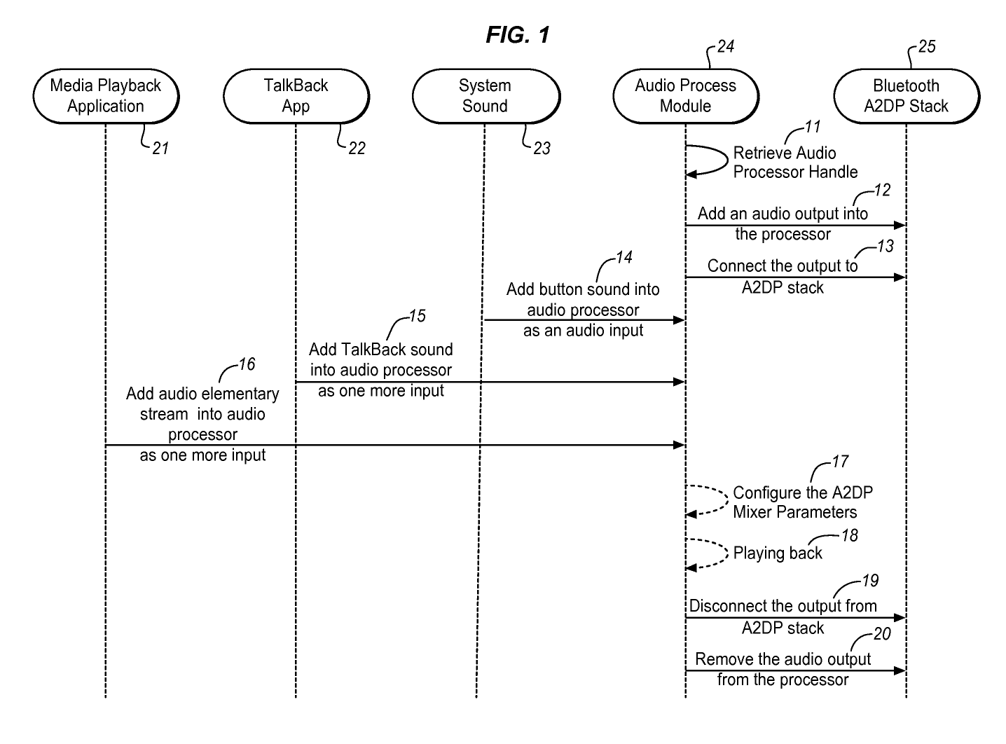

FIG. 1 is a communications flow diagram for a software stack that can be added to a television or set-top box operating system to improve performance and output quality. While the present example is shown in the context of a television with integrated processing resources or a set-top box that may be connected as an input to a television, similar techniques may also be applied to other entertainment components, such as receivers, players, and tuners, as well as to portable media players, smart phones, and similar devices. In one example the process flow may be implemented as a pipeline manager. FIG. 1 shows the components that may be configured to communicate through the pipeline manager. These components include a media playback application 21, a system menu or user interface sound application 22, such as the TalkBack application, system sound 23 such as button pushes and screen gestures contacts, a hardware audio process module 24, and an output component 25, such as a Bluetooth stack, WiFi stack WiDi (Wireless Display) stack, Ethernet stack, HDMI (High Definition Multimedia Interface), or any other output.

At 11 an audio processor handle is retrieved from an audio process module. The retrieved handle is then used to assemble inputs and outputs. At 12, an audio output is added into the audio process module. This operation may be a configuration operation using configuration registers or switches of the audio process module. At 13, the output is connected. The output may be connected to any of a wide range of different audio sinks, including devices, layers, and components. In the illustrated example, the output is added to a Bluetooth A2DP stack. However, it may be coupled to a different wireless or wired audio protocol stack or to a different wireless or wired interface, depending upon user configurations and selections.

With the output configured, any of a variety of different audio sources may be added as inputs to the audio process module. At 14, a button sound is added to the audio process module as an audio input. The button sound comes from the system to provide feedback to user inputs. At 15, TalkBack sound is added to the audio process module as an input. TalkBack is a name for spoken menus used by Google TV, however, other systems may use other names for speech input, menus and system guidance. The TalkBack sound comes from a TalkBack application. Accordingly, the software stack has not connected sound generated by an application to the audio process module for output through the A2DP stack. Any other application sound may be used in addition or instead of the TalkBack sound. The other applications may be push notifications, recommendations, command feedback, or application sound effects for other purposes.

At 16, an elementary audio stream is added as in input to the audio process module. This stream is the audio that the player is to play which comes from a media playback application. The audio may be from an audio only source, such as a music player application, Internet radio, or a telephone application or the audio may be from a video source, whether stored video or received video as a stream, as broadcast data or in other formats.

At 17, mixer parameters are configured. These parameters are applied to the mixer of the audio process module to mix audio from all of the audio inputs to then be supplied to the audio output. At 18, the mixed audio is applied to the configured audio output. In the illustrated example, the audio output is the A2CP stack so the audio is played back through a Bluetooth A2DP headset or remote speaker.

At the conclusion of the session, at 19 the output is disconnected from the A2DP stack, and at 20, the audio output is removed from the audio output module. The software stack may be reset for the next session by default or by specific user settings depending on the particular embodiment.

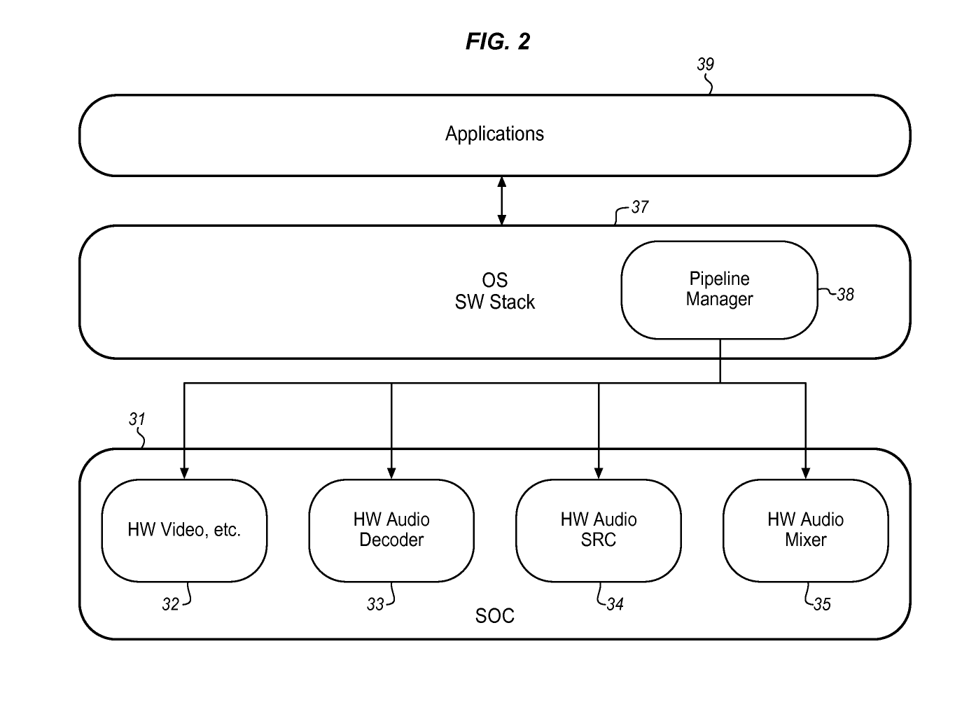

FIG. 2 shows the layered structure of a system to implement the process of FIG. 1. At the physical layer is a SOC 31. The SOC may include video processing 32, audio decoding 33, audio sample rate conversion 34 and an audio mixers. These facilities of the SOC are all accessible to the OS and configurable by the OS if the OS is so enabled. The OS software stack 37 is coupled to the physical layer resources to control their operation. A pipeline manager 38 is added to the OS stack in order to configure inputs and output in the physical layer as described above. Applications 39 interact with the OS in order to provide user interface, source selection and higher level processes.

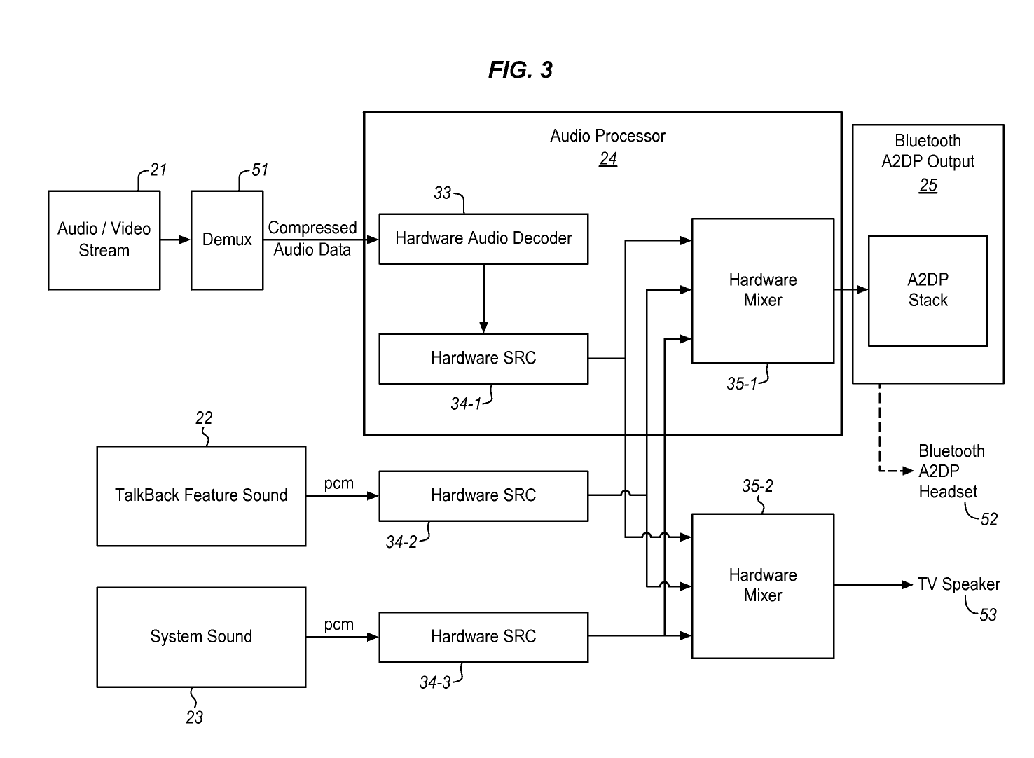

FIG. 3 is a diagram of the processes of FIG. 1 and how they interact in that example, through the layers of FIG. 2. A hardware audio processor 24 is part of an SOC or may be a separate set of components in the same package as a CPU or coupled to a CPU. The audio process module receives audio from one or more inputs. In the diagram the inputs include feature sound 22, generated by an application on the CPU, system sound 23 generated by an operating system on the CPU, and an audio or video stream 21, received from a communications or storage interface coupled to the system. Depending on the nature of the stream it may be demultiplexed in a demultiplexer 51 to assemble the data into audio and video components or to separate multiplexed components. It is then applied as compressed data to a hardware audio decoder 33.

The hardware audio decoder component 33 is included in the audio process module 24 to decode audio compressed data, such as AAC (Advanced Audio Codec), MP3 (Motion Picture Experts Group v. 3), etc. There may be one or more instances of the decoder depending on the particular embodiment.

The audio process module also includes one or more hardware audio sample rate converters (SRC) 34-1, 34-2, 34-3. These components are coupled to audio inputs to convert the audio sample rate of incoming or outgoing audio, for example converting from a 44.1k sample rate, common for recorded music to a 48k sample rate, common for recorded movies. A first SRC 34-1 is coupled to the audio/video stream 21. A second SRC 34-2 is coupled to the application feature sound 22 and a third SRC is coupled to the system sound 23. The sample rate converters are used in the illustrated embodiment to convert different sample-rate audio sources to a uniform sample rate before audio mixing.

A hardware audio mixer component 35-1, 35-2 is used to mix multiple audio data into a single audio output stream. A first hardware mixer 35-1 is coupled to all three audio sources on one side and to the A2DP stack 25 on the other side. The a2DP stack may be coupled to a Bluetooth headset 52, a speaker, or any other desired audio output device. A second hardware mixer 35-2 is coupled to the three audio sources and to a TV speaker 53 on the other side. The mixers, like the other components of the audio processor of the SOC may be connected to different inputs and outputs depending on the operation of the pipeline manager.

Using the illustrated configuration, the performance issues of a single microprocessor performing all of the described functions is resolved by introducing the hardware audio decoder, hardware sample rate converters and hardware mixers embedded in a SOC. In addition, as the SOC is configured, the A2DP headset and TV speaker can concurrently output the audio from media stream by adding a dedicated hardware mixer for A2DP output. Using independent audio mixers, each output can be configured as a user desires. The A2DP headset can be configured with or without the TalkBack sound and system sound in its output by changing the mixer parameters.

The result allows performance to be improved and enhances the benefit of the SOC. Bluetooth A2DP audio performance is maintained and the quality of the user experience is maintained as well.

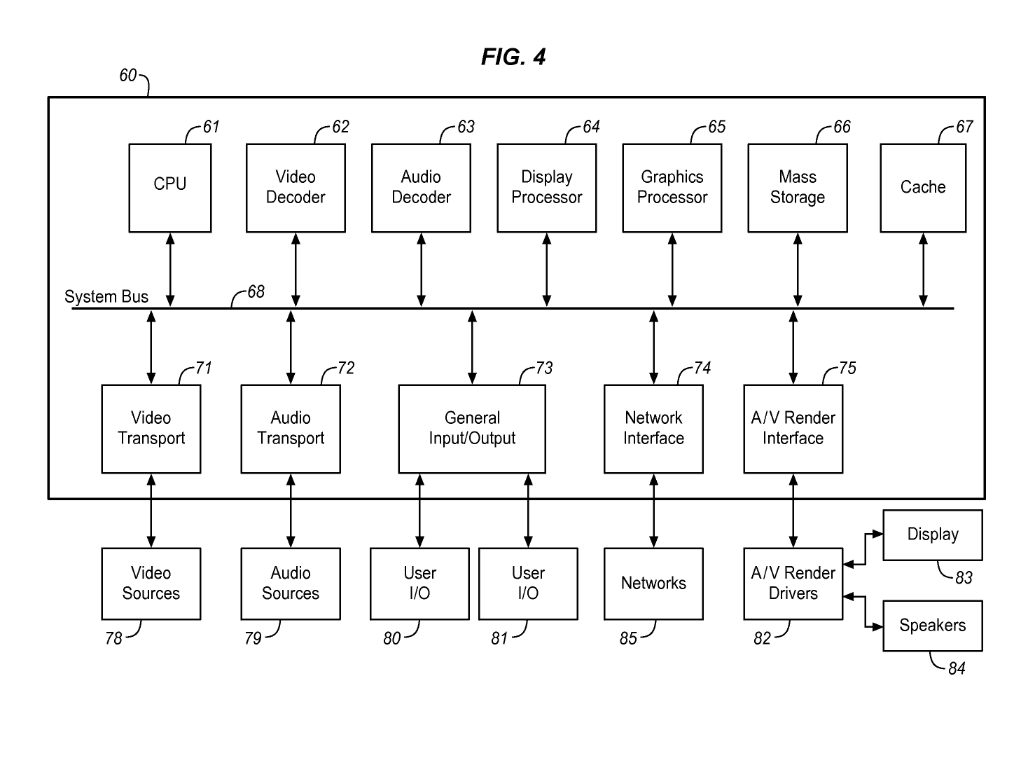

FIG. 4 is a block diagram of a television or set-top box implementing the techniques described above. The system uses an SOC 60 coupled to various peripheral devices and to a power source (not shown). A CPU 61 of the SOC runs an OS stack and applications and is coupled to a system bus 68 within the SOC. The OS stack includes or interfaces with the pipeline manager executed by the CPU and are stored in a mass storage device 66 also coupled to the bus. The mass storage may be flash memory, disk memory or any other type of non-volatile memory. The OS, the pipeline manager, the applications, and various system and user parameters are stored there to be loaded when the system is started.

The SOC may also include additional hardware processing resources all connected through the system bus to perform specific repetitive tasks that may be assigned by the CPU. These include a video decoder 62 for decoding video in any of the streaming, storage, disk and camera formats that the set-top box is designed to support. An audio decoder 63 as described above decodes audio from any of a variety of different source formats, performs sample rate conversion, mixing, and encoding into other formats. The audio decoder may also apply surround sound or other audio effects to the received audio.

A display processor may be provided to perform video processing tasks such as de-interlacing, anti-aliasing, noise reduction, or format and resolution scaling. A graphics processor 65 may be coupled to the bus to perform shading, video overlay and mixing and to generate various graphics effects. All of the hardware processing resources and the CPU may also be coupled to a cache memory such as DRAM (Dynamic Random Access Memory) or SRAM (Static RAM) for use in performing assigned tasks. Each unit may also have internal registers for configuration, and for the short-term storage of instructions and variables.

A variety of different input and output interfaces may also be provided within the SOC and coupled through the system bus or through specific buses that operate using specific protocols suited for the particular type of data being communicated. A video transport 71 receives video from any of a variety of different video sources 78, such as tuners, external storage, disk players, internet sources, etc. An audio transport 72, receives audio from audio sources 79, such as tuners, players, external memory, and internet sources.

A general input/output block 73 is coupled to the system bus to connect to user interfaces devices 80, such as remote controls or controllers, keyboards, control panels, etc. and also to connect to other common data interfaces for external storage 81. The external storage may be smart cards, disk storage, flash storage, media players, or any other type of storage. Such devices may be used to provide media for playback, software applications, or operating system modifications.

A network interface 74 is coupled to the bus to allow connection to any of a variety of networks 85 including local area and wide area networks whether wired or wireless. Internet media and upgrades as well as game play and communications may be provided through the network interface by providing data and instructions through the system bus. The Bluetooth A2DP stack described above is fed through the network interface 74 to a Bluetooth radio 85.

An Audio/Video Render interface 75 is also coupled to the system bus 68 to provide analog or digital audio/video output to an Audio/Video Render driver 82. The Audio/Video Render driver feeds a display 83 and speakers 84. Different video and audio sinks may be fed by the Audio/Video Render driver. The Audio/Video Render driver may be wired or wireless. For example, instead of using the network interface for a Bluetooth radio interface, the Audio/Video Render driver may be used to send wireless Bluetooth audio to a remote speaker. The Audio/Video Render driver may also be used to send WiDi (Wireless Display) video wirelessly to a remote display.

A lesser or more equipped system than the example described above may be preferred for certain implementations. Therefore, the configuration of the exemplary system on a chip and set-top box will vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

In embodiments, the invention may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, etc.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1-17. (canceled)

18. A method comprising:
adding an audio input to a hardware audio module using a pipeline manager coupled to an operating system running on a processor;
connecting the audio input to an audio source using the pipeline manager;
adding an audio output to the hardware audio module using the pipeline manager; and
connecting the audio output to an audio sink using the pipeline manager.

19. The method of claim 18, further comprising:
adding a second audio input to the hardware audio module;
connecting the second audio input to a second audio source;
connecting the first and second audio inputs to a mixer of the hardware audio module; and
connecting the audio output to the mixer so that the input audio is mixed before being provided to the audio output.

20. The method of claim 18, further comprising configuring the mixer using the pipeline manager.

21. The method of claim 18, further comprising:
disconnecting the output from the audio sink; and
removing the audio output from the hardware module.

22. The method of claim 18, wherein the audio sink is a protocol stack.

23. The method of claim 19, further comprising:
adding a sample rate converter to the hardware audio module;
connecting the second audio input to the sample rate converter to convert the sample rate of the second audio input to the sample rate of the first audio input; and
providing the sample rate converted second audio input to the mixer using the pipeline manager.

24. The method of claim 18, wherein the pipeline manager is within the operating system.

25. The method of claim 18, further comprising retrieving an audio processor handle from the hardware audio module and wherein adding an audio input comprises adding an audio input into the hardware audio module using the retrieved handle.

26. The method of claim 18, wherein connecting the audio output comprises connecting the audio output to a Bluetooth audio distribution stack.

27. An apparatus comprising:
a hardware audio module having a configurable audio input and a configurable audio output;
a central processing unit to execute an operating system;
a pipeline manager to configure the hardware audio module in response to a call from the operating system, the pipeline manager to connect the audio input to an audio source and to connect the audio output to an audio sink.

28. The apparatus of claim 27, wherein the hardware audio module further comprises an audio mixer and a second audio input, the pipeline manager further to connect the second audio input to a second audio source, to connect the first and second audio inputs to the mixer. and to connect the audio output to the mixer so that the input audio is mixed before being provided to the audio output.

29. The apparatus of claim 28, wherein the hardware audio module further comprises a sample rate converter. the pipeline manager further connecting the second audio input to the sample rate converter to convert the sample rate of the second audio input to the sample rate of the first audio input and configuring the hardware audio module to provide the sample rate converted second audio input to the mixer.

30. The apparatus of claim 27, the pipeline manager further disconnecting the output from the audio sink and removing the audio output from the hardware module.

31. The apparatus of claim 27, wherein the audio sink is a protocol stack.

32. A machine-readable medium having instructions thereon that when executed by the machine causes the machine to perform operations comprising:
adding an audio input to a hardware audio module using a pipeline manager coupled to an operating system running on a processor;
connecting the audio input to an audio source using the pipeline manager;
adding an audio output to the hardware audio module using the pipeline manager; and
connecting the audio output to an audio sink using the pipeline manager.

33. The medium of claim 32, wherein the operations further comprise:
adding a second audio input to the hardware audio module;
connecting the second audio input to a second audio source;
connecting the first and second audio inputs to a mixer of the hardware audio module; and
connecting the audio output to the mixer so that the input audio is mixed before being provided to the audio output.

34. The medium of claim 32, wherein the operations further comprise configuring the mixer using the pipeline manager.
